(19) United States
(12) Patent Application Publication
(10) Pub. No.: US 2008/0115403 A1
(43) Pub. Date: May 22, 2008

(54) Elastomeric Fishing Lure Body And Method Of Making The Same

(76) Inventors: Michael T. Shelton, North Charleston, SC (US); Joseph L. Myers, Mt. Pleasant, SC (US)

Correspondence Address: HAMMER & HANF, PC, 3125 SPRINGBANK LANE, SUITE G, CHARLOTTE, NC, 28226, US

(21) Appl. No.: 11/817,796

(22) PCT Filed: Mar. 14, 2006
(86) PCT No.: PCT/US06/08874

§ 371 Date: Sep. 5, 2007

Related U.S. Application Data
(60) Provisional application No. 60/661,455, filed on Mar. 14, 2005.

(51) Int. Cl. A01K 85/00

(52) U.S. Cl. 43/42.24

(57) ABSTRACT

An elastomeric fishing lure comprising a body having a Shore OO hardness of 10-20. The body is comprised of an oil, where the oil is 79-84% by weight of the body and a styrenic block copolymer which is 14 to 21% by weight of the body. This styrenic block copolymer is selected from the group of: SBS (styrene butadiene styrene), SIS (styrene-isoprene-styrene), SEPS (styrene ethylene/propylene styrene), SEBS (styrene ethylene/butylene styrene), and SEEPS (styrene ethylene/ethylene-propylene-styrene) and combinations thereof. The body may also have an additive selected from the group of: anti-oxidants, heat stabilizers, oxidation inhibitors; in an amount from 0 to 5% by weight.

### FIELD OF THE INVENTION

A fishing lure made of a synthetic rubber composition which has improved feel and performance.

### BACKGROUND OF THE INVENTION

Fishing lures and baits which are made from plastisol are commercially available. Plastisol is a dispersion or emulsion of polyvinyl chloride (PVC) resin in a plasticizer. Lures and baits made of various plastisols have been widely accepted, as they appear lifelike. They can be molded into various shapes, are easily colored, and are relatively inexpensive. The plastisol fishing bait, however, is deficient in that it is not very elastic, it is susceptible to tearing, it is relatively hard (salt water lure—Shore OO hardness 35-40; fresh water lure—Shore OO hardness of more than 20). These Plastisol lures are perceived as environmentally unsafe, and while they may appear lifelike, they do not feel lifelike.

Recently fishing lures have started to be made of a synthetic rubber as opposed to plastisols. Some examples of these types of lures can be seen in U.S. Pat. Nos. 4,589,223, 5,884,639, 6,117,176, and 6,148,830. Specifically, these synthetic rubbers are thermoplastic elastomers (TPE); and more specifically, they are styrenic block copolymer. These new lures show some improvement and draw backs over the plastisol lures. The new lures can be colored, shaped, are softer, and are elastic. These new lures not only look lifelike, but they also feel lifelike.

These synthetic rubbers, however, were not problem-free. One concern is the surface tackiness of the lure. The synthetic rubber has a high surface tack; therefore, it tends to cling to anything it comes into contact with. One solution to the surface tack concern is set forth in copending U.S. patent application Ser. No. 10/378489 filed Mar. 3, 2003 by M. T. Shelton. Another concern is heat deformation. Heat deformation refers to the body losing its original shape after being exposed to an elevated temperature for a prolonged period of time (e.g. 50° C. for 1 hour). For example, a worm-shaped lure (i.e., generally rod-like) may be bent or folded in storage, and during storage, it may see temperatures greater than 100° F. (38° C.), and after cooling, the bent or folded worm may not return to its original shape. Heat deformation is undesirable from a consumer point-of-view. One solution to the surface tack and heat deformation is set forth in copending U.S. patent application Ser. No. 10/460,064 filed Jun. 6, 2003 by M. T. Shelton and others. Still other considerations include maintaining elasticity and tear resistance. Each of these properties must be balanced to achieve a good quality lure. Some of these synthetic rubber lures had too much elasticity and heat deformation remained a problem. These lures had a Shore OO hardness of less than 10. In addition it was found that with low Shore OO lures there was a problem with keeping the lure on the hook. These properties, it is believed, are dependent, in part, on the choice of the components of the synthetic rubber composition and their relative quantities in the mixture as well as their relation to the amount of plasticizer which they are mixed with.

### SUMMARY OF THE INVENTION

An elastomeric fishing lure comprising a body having a Shore OO hardness of 10-20. The body is comprised of an oil, where the oil is 79-84% by weight of the body and a styrenic block copolymer which is 14 to 21% by weight of the body. This styrenic block copolymer is selected from the group of: SBS (styrene butadiene styrene), SIS (styrene-isoprene-styrene), SEPS (styrene ethylene/propylene styrene), SEBS (styrene ethylene/butylene styrene), and SEEPS (styrene ethylene/ethylene-propylene-styrene) and combinations thereof. The body may also have an additive selected from the group of: anti-oxidants, heat stabilizers, oxidation inhibitors; in an amount from 0 to 5% by weight.

### DETAILED DESCRIPTION

The elastomeric composition of this invention is a mixture of a thermoplastic elastomer (TPE) and an oil (or plasticizer). Preferably, this composition is a mixture of a styrenic block copolymer and an oil, where the oil is in excess, by weight, of the copolymer. Most preferably, the composition is a mixture of one or more styrenic block copolymers in an oil.

These elastomeric compositions are elastic, tear resistant, and life-like. The compositions are no so soft as to be tacky or easily deformed. They are elastic and can be stretched several times their original length. They are tear resistant and can withstand tearing. They are soft and have a Shore OO hardness of from 10-20. In another embodiment of the invention the elastomeric bodies have a Shore OO hardness of 11-19. The Shore hardness is measured with an apparatus known as a Durometer and consequently is also known as ‘Durometer hardness’. The hardness value is determined by the penetration of the Durometer indenter foot into the sample. Because of the resilience of rubbers and plastics, the indentation reading my change over time—so the indentation time is sometimes reported along with the hardness number. The ASTM test method designation is ASTM D2240 00 and is generally used in North America. Related methods include ISO 7619 and ISO 868; DIN 53505; and JIS K 6301, which was discontinued and superseded by JIS K 6253. The results obtained from this test are a useful measure of relative resistance to indentation of various grades of polymers. The lures having this durometer range have been found to be highly effective for both fresh and salt water fishing.

The styrenic block copolymers are thermoplastic elastomers. Their structure normally consists of a block of a rigid styrene on each end with a rubbery phase in the center. Styrenic block copolymers include, but are not limited to, SBS (styrene butadiene styrene), SIS (styrene-isoprene-styrene), SEPS (styrene ethylene/propylene styrene), SEBS (styrene ethylene/butylene styrene), and SEEPS (styrene ethylene/ethylene-propylene-styrene). These materials are commercially available from, for example, SEPTON Company of America, Pasadena, Texas and Kraton Polymers, Houston, Tex. Exemplary SEPTON (US) products include SEPTON 4055 (SEEPS); SEPTON 8006 (SEBS); and SEPTON 2006 (SEPS). Exemplary Kraton (US) products include KRATON 1651 (SEBS).

The oil or plasticizer generally refers to mineral oils or silicone (dimethyl silaxone) oil. The oil is mixed with the styrenic block copolymer. Such oils are commercially available from, for example, Crompton Corporation (Witco Refined Products), Greenwich, Connecticut. Exemplary oils include: BLANDOL white mineral oil, specific gravity@25° C./25° C. (ASTM D4052)−0.839/0.855; Kinematic viscosity@40° C., CST (ASTM D445)−14.2/17.0 (heavy oil), and SEMTOL white mineral oil, specific gravity@25° C./25° C. (ASTM D4052)−0.804/0.827, Kinematic viscosity@40° C., CST (ASTM D445)−3.9/5.5 (light oil).

With the oils it is preferred that the one selects an oil having a viscosity of from 20 to 120 cps at 40° C. It also has been learned that a mixture of oils having two different viscosities where the oil having the lower viscosity is used in excess of the oil having a higher viscosity is used gives improved results. Specifically this combination tends to reduce tack in the resulting mixture. In doing so the resulting mixture of oils should have a viscosity of from 20 to 120 cps at 40° C.

Other conventional additives may also be added. Such additives include: UV-stabilizer, heat-stabilizer, pigments, dyes, flavorant, attractants, and the like. Some examples of a heat stabilizer or oxidation inhibitor is Endex 160 a hydrocarbon resin which is available from Eastman Chemical Company. An example of a UW-stabilizer is Tinuvin available from Ciba specialties chemicals. An Example of an anti-oxidant is Iriganox HP2215FF available from Ciba specialties chemicals.

In the elastomeric composition, the oil is in excess, by weight, of the styrenic block copolymer. The copolymer may comprise 14-21% by weight of the composition, while the oil may comprise 84-79% by weight of the composition.

The copolymer component of the composition may comprise a single copolymer or a mixture of copolymers. If a single copolymer is used, SEBS is preferred, although other single copolymers could be used. If a mixture of copolymers is used, SEEPS and SEBS or SEPS/SEBS combinations work well. Lures made with SEBS alone are adequate from an elastic and tear resistance perspective, but mixtures can provide superior elastic and tear resistant properties. In the mixtures, in one embodiment the SEEPS component can be the major component. Exemplary copolymer component for a mixture formulations include 6-13% SEEPS, 1-11% SEBS, 0-4% SEPS.

In another embodiment of the present invention an elastomeric fishing lure having a shore OO durometer of from 10 to 20 where the body is comprised of an oil, a styrenic block copolymer, a hardness enhancer selected from the group consisting of: salt, glitter, bio-matter hardness enhancer, inert hardness enhancers and combinations thereof; and optionally an additive.

In this application we reference to a hardness enhancer as a material which increases the hardness of the combination of oil and styrenic blocked copolymer. In this group glitter can be a foil, metal, mica or can be a colored Mylar or a colored polyester or any other material which would have the reflective properties associated with glitter. For bio-matter hardness enhancer it is contemplated to use any bio-matter which would raise the hardness of the fishing lure and may also provide some attractant properties to the lure. Examples of this type of material include but are not limited to freeze dried or ground up crawfish, shrimp, insects, fish or any other naturally occurring living matter which would increase the hardness of the composition and which may act as a natural attracted to the fish.

Inert hardness enhancers include but are not limited to silica, small glass spheres, small ceramic spheres, silica gels, natural silicas, fumed silicas, minerals, zeolites (natural or synthetic), organic materials, decorative or ornamental compounds, pigments, and combinations thereof. The minerals may be selected from the group consisting of talcs, china clays, chalks, limestone, mica, coated mica, and mixtures thereof. The organic materials may be selected from the group of spherical silicon resins (e.g., Tospearl® from G.E. Silicones), methylmethacrylate resins (e.g., Epostar® from Nippon Shokobai), and combinations thereof. The decorative or ornamental compounds may be selected from the group consisting of glitters, pearlizing agents, flocking, beads, reflective coatings, and combinations thereof. The pigments may be selected from the group consisting of interference pigments, iridescent pigments, and combinations thereof. This hardness enhancer may be a fumed silica. Such fumed silicas are commercially available under the tradename CAB-O-SIL® EH-5 from Cabot Corporation, Tuscola, Ill. and ZEOTHIX® from J.M. Huber Corporation, Havre de Grace, Md.

The shaped bodies for the fishing lures or bait of the present invention can be produced by the process of: mixing oil with a styrenic block copolymer. The styrenic block copolymer mixture and oil mixture are then extruded. The extruded mixture of styrenic block copolymer and oil are then ground in a grinder. A meat grinder can be used for this step. This mixture of styrenic block copolymer and oil can then be extruded into the desired shape. This desired shape has a Shore OO durometer of from 10 to 20. It should be noted that color can be added at any point in this process. As used here color or colorant can be pigments, dyes, glitter, mica tinting pastes or combinations thereof. The colored mixture of styrenic block copolymer and oil can then be extruded into the desired shape.

In this process it is also possible to use a combination of styrenic block copolymers, oil, a hardness enhancer and optionally an additive so that the desired shape has a Shore OO durometer of from 10-20. The hardness enhancer is selected from the group consisting of: salt, glitter, bio-matter hardness enhancer, inert hardness enhancers and combinations thereof. These hardness enhancers are described in greater detail above.

With this process the method of producing a shaped body of an elastomeric composition for use as a fishing lure or bait may comprise the steps of mixing an oil with a styrenic block copolymer and extruding a mixture of said styrenic block copolymer and said oil to form an extruded mixture. This extruded mixture and be pelletized or granulated to facilitate later processability. This process may also use a hardness enhancer or optionally an additive in order to obtain a resulting shaped object which has a Shore OO durometer from 10 to 20.

If the starting materials are provided in pellets or a grind it is then possible to use these pellets or the grind which could then be melted and extruded into the desired shaped or mixed with colorants or other additives or viscosity enhancers melted and extruded into the desired shape.

Lures and baits may come in many various shapes. Lure and bait are used interchangeably herein. For example, the shape may be that of a lizard or a worm. Other shapes include: salamanders, fan tails, curly tail jigs, quad tail jigs, curly tail worms, split-tails, worm-crawfish, minnows, double tails, ripple tail worms, and the like. Further, the shape may also include a ‘rattle pocket’ for a rattle. For example, see U.S. Pat. No. 4,993,183 and U.S. Patent Application Publication No. 2002/0188057A1, both incorporated herein by reference.

With this type of fishing lure it has been found that if one is using a styrenic block copolymer that because of the elongation and tear resistance the lures that work well having a Shore OO durometer of ten or more but also should have a shore OO durometer of twenty or less. If one makes a lure that has a shore of more than 20 then the hook tends not to come through the lure. In this range the lure tends to act as a hook guard. With lures having a durometer of less than 10 the lures tend to slide on the hook or ball up on the hook so, that bait does not have a appearance the fisherman is looking for. Plastisol lures having a durometer of more than 20 still tend to work because the material has less elongation and much lower shear strength. Therefore when the fish strikes the lure, the lure tends to break but this allows the hook to be set. The disadvantage is the lures tend not to be able to be reused.

In another embodiment of this invention it has been found that the lures made with the combination of oil and styrenic block copolymers have a specific gravity of less than one. This means that the lure will float on water or underwater off of a weight to the advantage of the fisherman in certain circumstances However, what a starting material with specific gravity of less than one allows is that with the addition of the hardness enhancers listed above the specific gravity of the lure can be varied to regulate the buoyancy from surface floating, to neutral, to having a controlled sink rate. It will be noted that most of the hardness enhancers listed above tend to increase the specific gravity of the lure, however, the small hollow glass beads or small hollow ceramic beads will tend to increase buoyancy or decrease the overall specific gravity of the lure. It is noted that in examples A-H listed below the specific gravity is less than 1. With the addition of sufficient salt or metal glitter the specific gravity can be altered so that the lure has a neutral buoyancy or it sinks or it has a controlled sink.

By contrast plastisol lures start with a specific gravity of more than one so that they sink. In order to make these plastisol lures more buoyant one needs to add hollow glass or ceramic beads. However this addition, further deteriorates their stretch and tear resistance, making them more easy to break. Additionally some of the desired coloring is not available because with the addition of hollow spheres the lure must be opaque.

With the instant invention it is possible to create translucent or opaque lures in a full range of colors and have the lures be either buoyant, neutral, sink or have a controlled sink rate based on the amount of hardness enhancers that are added.

It should be noted that lures engineered for use in salt water would tend to have higher specific gravities for them to be neutral, sink or have a controlled sink. Salt water tends to range from a specific gravity of 1.017 to 1.025 or more depending on the body of water, salinity, temperature and location.

### EXAMPLES

In the tables below are some examples of formulations for lures which have a Shore OO durometer measurement in the range of 10 to 20.

sample#

| Component | A | B | C | D |
|---|---|---|---|---|
| oil | 84% | 83% | 82% | 81% |
| SEEPS | 7% | 7% | 7% | 9% |
| SEPS | 3% | 3% | 3% | 2% |
| SEES | 4% | 4% | 6% | 6% |
| Other additives | 2% | 2% | 2% | 2% |
| Total | 100 | 100 | 100 | 100 |
| Durometer | 10 | 12 | 15 | 18 |

sample#

| Component | E | F | G | H |
|---|---|---|---|---|
| oil | 88% | 81% | 82% | 82% |
| SEEPS | 4% | 0% | 6% | 0% |
| SEES | 7% | 19% | 11% | 17% |
| SEES | 1% | 0% | 1% | 0% |
| Other additives | 0% | 0% | 0% | <.1% |
| Total | 100 | 100 | 100 | 100 |
| Durometer | 6.6 | 18.2 | 15.9 | 14.8 |

In Example I 21% of Oil A was mixed with 62% of oil B and 5% SEEPS and 17% SEBS to form 18.14 Kg of material which had an initial durometer of 12.27. To this mixture 3.18 Kg of salt was added. The addition of the salt raised the Shore OO durometer of the material from 12.27 to 15.25. In this example Oil A had a higher viscosity than Oil B.

1. An elastomeric fishing lure comprising a body having a Shore OO hardness of 10-20.

2. The elastomeric fishing lure according to claim 1 where said body further comprises an oil, where said oil is 79-84% by weight of said body.

3. The elastomeric fishing lure according to claim 1 where said oil has a viscosity from 20-120 cPs at 40° C.

4. The elastomeric fishing lure according to claim 2 where said oil is selected from the group of: mineral oil, silicone oil or mixtures thereof.

5. The elastomeric fishing lure according to claim 1 where said body further comprises mixture of a styrenic block copolymer at 14 to 21%.

6. The elastomeric fishing lure according to claim 5 where said styrenic block copolymer is selected from the group of: SBS (styrene butadiene styrene), SIS (styrene-isoprene-styrene), SEPS (styrene ethylene/propylene styrene), SEBS (styrene ethylene/butylene styrene), and SEEPS (styrene ethylene/ethylene-propylene-styrene) and combinations thereof.

7. The elastomeric fishing lure according to claim 1 where said body further comprises from 0 to 4% of additives selected from the group of: anti-oxidants, heat stabilizers, oxidation inhibitors.

8. The elastomeric fishing lure according to claim 1 where said body is free from any added salt.

9. The elastomeric fishing lure according to claim 4 where said oil is a blend of at least two different oils having different viscosities, a lower viscosity oil and a higher viscosity oil where said lower viscosity oil is used in excess of said higher viscosity oil.

10. The elastomeric fishing lure according to claim 1 where said body has a Shore OO hardness of 11-19.

11. The elastomeric fishing lure according to claim 1 where said body further comprises:
an oil, where said oil is 79-84% by weight of said body;
a styrenic block copolymer which is 14 to 21% by weight of said body and said styrenic block copolymer is selected from the group of: SBS (styrene butadiene styrene), SIS (styrene-isoprene-styrene), SEPS (styrene ethylene/propylene styrene), SEBS (styrene ethylene/butylene styrene), and SEEPS (styrene ethylene/ethylene-propylene-styrene) and combinations thereof;
an additive selected from the group of: anti-oxidants, heat stabilizers, oxidation inhibitors; in an amount from 0 to 4% by weight.

12. The elastomeric fishing lure according to claim 1 where said body further comprises:
an oil;
a styrenic block copolymer;
a hardness enhancer selected from the group consisting of: salt, glitter, bio-matter hardness enhancer, inert hardness enhancers and combinations thereof; and
optionally an additive.

13. A fishing lure comprising a shaped body of an elastomeric composition comprising:
a styrenic block copolymer of 14 to 21% by weight which comprises:

| | |
|---|---|
| 0-21% | SEEPS by weight |
| 0-21% | SEPS by weight |
| 0-21% | SEBS by weight |
| 0-21% | SBS by weight |
| 0-21% | SIS by weight |

and 79-84% oil by weight and where the fishing lure has a Shore OO hardness of 10-20 before addition of salt.

14. The fishing lure according to claim 13 where said styrenic block copolymer is selected from the group of: SEPS (styrene ethylene/propylene styrene), SEBS (styrene ethylene/butylene styrene), and SEEPS (styrene ethylene/ethylene-propylene-styrene) and combinations thereof.

15. The fishing lure according to claim 13 where said oil has a viscosity from 20-120 cPs at 40° C.

16. The elastomeric fishing lure according to claim 13 where said oil is selected from the group of: mineral oil, silicone oil or mixtures thereof.

17. The elastomeric fishing lure according to claim 13 where said body further comprises from 0 to 4% of additives selected from the group of: anti-oxidants, heat stabilizers, oxidation inhibitors.

18. The elastomeric fishing lure according to claim 13 where said body further comprises a hardness enhancer selected from the group consisting of: salt, glitter, bio-matter hardness enhancer, inert hardness enhancers and combinations thereof.

19. The elastomeric fishing lure according to claim 13 where said oil is a blend of at least two different oils having different viscosities, a lower viscosity oil and a higher viscosity oil where said lower viscosity oil is used in excess of said higher viscosity oil.

20. The elastomeric fishing lure according to claim 19 where said blend of at least two different oils having different viscosities has a combined viscosity of from 20-120 cPs at 40° C.

21. A method of producing comprising a shaped body of an elastomeric composition for use as a fishing lure or bait comprising the steps of:
mixing an oil with a styrenic block copolymer;
extruding a mixture of said styrenic block copolymer and said oil to form an extruded mixture;
grinding said extruded mixture to form a ground extruded mixture; and
extruding said ground extruded mixture into a desired shape.

22. The method according to claim 21 where a colorant can be added at any point in the process.

23. The method according to claim 21 where styrenic block copolymers and oil are added so that said desired shape has a Shore OO durometer of from 10-20.

24. The method according to claim 21 where styrenic block copolymers, oil, a hardness enhancer and optionally an additive are added so that said desired shape has a Shore OO durometer of from 10-20,
where said hardness enhancer is selected from the group consisting of: salt, glitter, bio-matter hardness enhancer, inert hardness enhancers and combinations thereof.

25. An elastomeric fishing lure having a Shore Co durometer of from 10 to 20 having a body where said body comprises:
an oil;
a styrenic block where said styrenic block copolymer is selected from the group of: SBS (styrene butadiene styrene), SIS (styrene-isoprene-styrene), SEPS (styrene ethylene/propylene styrene), SEBS (styrene ethylene/butylene styrene), and SEEPS (styrene ethylene/ethylene-propylene-styrene) and combinations thereof; and
where said lure has a specific gravity of less than one.

26. The elastomeric fishing lure according to claim 25 which further comprise: an additive, a hardness enhancer or combinations thereof;
where said additive is selected from the group consisting of: anti-oxidants, heat stabilizers, oxidation inhibitors, UV-stabilizers and combinations thereof; and
where said hardness enhancer is selected from the group consisting of: salt, glitter, bio-matter hardness enhancer, inert hardness enhancers and combinations thereof.

27. The elastomeric fishing lure according to claim 26 which further includes a hardness enhance where said harness enhance can either selectively increase or decrease the specific gravity of said elastomeric fishing lure.

28. The elastomeric fishing lure according to claim 27 where said elastomeric fishing lure has a specific gravity of less than 1.

29. The elastomeric fishing lure according to claim 27 where said elastomeric fishing lure has a specific gravity of more than 1.

30. The elastomeric fishing lure according to claim 27 where said elastomeric fishing lure has a specific gravity of 1.
